(19) United States
(12) Patent Application Publication
(10) Pub. No.: US 2008/0053291 A1
(43) Pub. Date: Mar. 6, 2008

(54) ADJUSTABLE VENTURI FOR A DRUM

(76) Inventor: Ronn Dunnett, Delta (CA)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/854,223

(22) Filed: Sep. 12, 2007

Related U.S. Application Data
(63) Continuation-in-part of application No. 10/993,476, filed on Nov. 22, 2004, now Pat. No. 7,291,776.
(60) Provisional application No. 60/527,858, filed on Dec. 8, 2003.

(51) Int. Cl. G10D 13/02

(52) U.S. Cl. 84/411 R

(57) ABSTRACT

A drum which has a cylindrical drum wall with a top edge and a bottom edge. The drum also has a top head arranged about the top edge of the cylindrical drum wall; a bottom head arranged about the bottom edge of the cylindrical drum wall; the top head, the bottom head, and the cylindrical drum wall defining an airtight inner region and an exterior region. The top head configured to be struck by a beater, to create an enhancement of air pressure within said airtight inner region. A first valve is arranged on the drum and configured to regulate the enhancement of air pressure between the airtight inner region and the exterior region.

### RELATED APPLICATIONS

This application claims priority from provision application Ser. No. 60/527,858, filed Dec. 8, 2003. This application claims priority benefit of U.S. Ser. No. 10/993,476, filed Nov. 22, 2004.

### BRIEF DESCRIPTION OF THE DRAWINGS

FIG. 1 is a cross-sectional view of one embodiment in the open position and mounted to the drum shell;

FIG. 1A is a fragmentary section showing a closed position of the FIG. 1 valve;

FIG. 1B is a fragmentary section showing detenting means to hold a valve spool in selected position for adjustable venting;

FIG. 2 is a bottom perspective view of the drum shell with one embodiment mounted to the shell;

FIG. 3 is a cross-sectional view of an alternate embodiment;

FIG. 4 is a cross-sectional view of an alternate embodiment;

FIG. 5 is a perspective exploded view of an alternative embodiment of the valve;

FIG. 6 is a perspective view of a second alternative embodiment of the valve about the drum wall;

FIG. 7 is a perspective view of a third alternative embodiment of the valve about the drum wall.

### DESCRIPTION OF THE PREFERRED EMBODIMENTS

Generally speaking, the concept is directed to an air throttling valve, which is arranged on a sealed drum. The drum may be hermetically sealed allowing no air to extend out of the drum without first passing through the air throttling valve. The valve allows the user to control and modulate movement of air and vibration traveling into and out of the drum either by allowing the user to adjust the valve manually, or by setting a self actuation threshold. The valve may be adjustably set, providing the release of internal air pressure and according to the threshold limit set on the valve as related to the pressure in the drum. The vent may have a mechanism which enables it to be fully opened or fully closed. A user can adjust an aperture size to an intermediate setting which provides for a range of settings between the fully opened and fully closed positions. One embodiment allows the valve discussed above to be fitted onto a pre-existing opening within a drum casing or in a drum wall, i.e. a top wall or a bottom wall. With the air pressure exiting through the vent, regulation of air pressure allows for attenuated expansion and contraction of drumheads. The drumheads may be made of organic membranes. The adjustable vent can be incorporated into other components of the drum; these drum components being as follows: the drum shell, the drum walls, etc. In an alternative embodiment, the valve may be removed allowing for microphones to be inserted into the drum cavity; further, the valve provides a pressure release mechanism for drum during travel, enabling pressure which may increase during a changing altitude or temperature to be released thus preserving the drum membranes and the integrity of the drum. As indicated above, the valve may be self activating and the threshold or tolerance for the self actuation may be set to allow for internal air pressure to be released under various playing conditions. While one valve has been discussed, multiple valves may be placed about the drum for further attenuation or further user ergonomics, depending on the playing skill and technique of the user. All or parts of the valve or multiple valves can be removed allowing for traditional open hole venting, and as previously discussed, the valve may be fitted to the drum head.

Generally speaking, a first embodiment of the drum has the following nonexclusive list of characteristics: a drum with a drumhead which can be struck by a beater. The striking of the drumhead with the beater creates an enhancement of air pressure within the drum. The drum has an adjustable valve carried on the drum. The adjustable valve has an adjustment for venting of air pressure from within the drum to the exterior of the drum. The valve has an airflow throttling component or plurality of components. The drum casing is sealed when the valve or valves are in the closed position.

While not necessary, the valve may be carried by the drum shell. The adjustment may include a movable adjuster for varying flow of air through the valve from the drum interior to the drum exterior. The valve may extend into the drum shell, extending into the drum shell may be defined by a body of the valve. The drum shell may have an opening for the body to be extended into the drum shell. The adjuster may extend from within the valve body to the exterior of the drum shell. The adjuster enables manual control between selected positions for specific venting control of the air from the interior to the exterior and vice versa.

The adjuster may be provided in an axially movable adjusting stopper embodiment. The seat is engageable by the stopper, where the stopper is accessible from the exterior of the drum. The adjuster may have radially extending airflow throttles or throttling holes which communicate with the drum exterior, and the adjuster may have axial porting holes that communicate with the vent holes and the drum exterior.

The adjuster may also take the form of a tubular spool which is received for axial movement within a valve body bore. There may be first and second phone O-rings on the spool; the primary channel in the spool in between such the O-rings to receive flow from the tubular splew, enabling a secondary channel in the valve body to receive flow from the primary channel. There may also be a tertiary channel in the spool to receive flow from the secondary channel for venting of air to the exterior via the various selected ports in the spool.

In addition, a means to hold the adjuster in different positions may be provided to adjust throttling action, to allow different drumming sound effects etc.

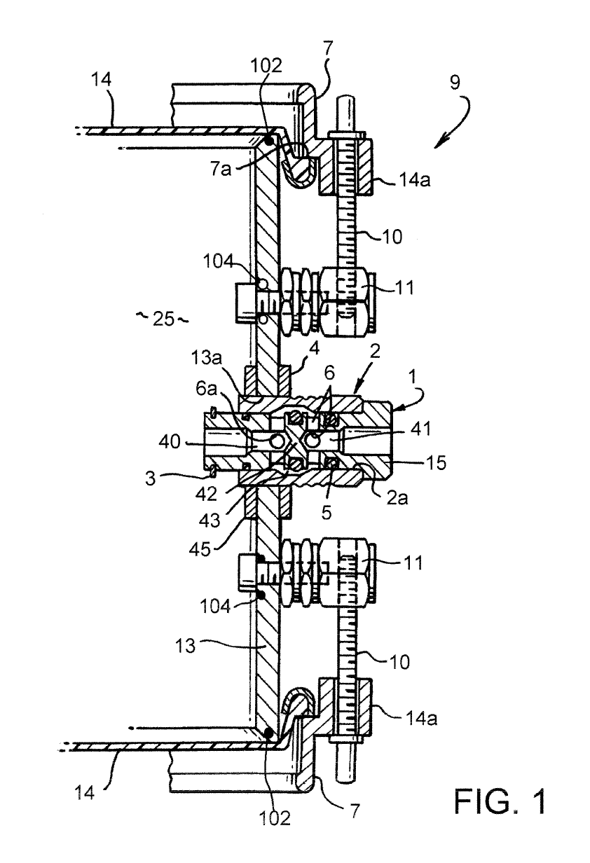

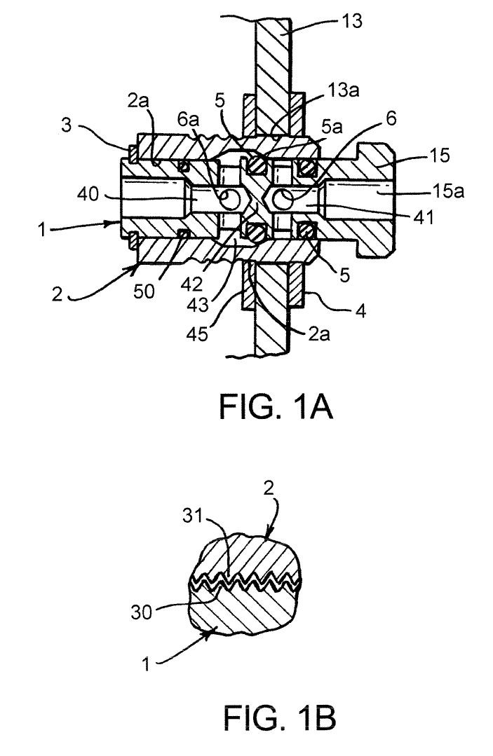

Referring to FIG. 1, a drum 9 has a drum shell 13 to which are attached a series of lugs 11. In one embodiment, the lugs have a body portion located within the inner region of the drum shell 13. A gasket 104 is located on the inner region and forms an air tight seal between the inner portion of the lug 11 and the drum shell 13. This gasket may be arranged in an O-ring type arrangement. Drumheads 14 are held in place by hoops 7 which press down on the head retainer at location 7A. Tension is applied to the drumheads 14 by a flange 14A where the tension is transferred through adjustable tension rods 10 which engage the hoops and thread into the lugs 11. Drumheads 14 are in contact with the drum shell 13 and form an air tight seal at the intersection between the drumhead and the hoop where the gasket 102 is located. The gasket 102 for example can be an O-ring seal and is configured to maintain the air tight seal also between the drumhead 13 and the drum shell 14.

The same arrangement occurs at the top wall and bottom wall of the respective drum heads. With the drum casing completely sealed, the valve 2 acts as an airflow control, the airflow control valve completely regulating the flow of the air into and out of the inner region 101 of the drum 9.

In an alternative embodiment, the air cased in the drum 9 acts as a hydraulic and transfers the exterior pressure from the beater on the top drumhead wall to the bottom drumhead wall. The air pressure can be regulated and relieved through the manual mechanism or the preset automatic valve.

A sudden force imparting a shockwave on say for example the top wall of the drumhead will be immediately transmitted to the opposite end of the drum cylinder at the bottom wall of the drumhead.

In an alternative embodiment of the spool valve 2, the valve is installed into a hole 13A located within the shell 13 and is held in place by a retaining clip 4. The adjustable throttle body 1 is installed into the bore 2A of valve 2 and contains a series of channels around the circumference into which are fitted rubber gaskets or O-rings 5. A series of radial holes 6 around the circumference of the tubular throttle body 1 allow for the flow of air and vibration between the body bore sections 40 and 41, and around bore restriction 42, and via bypass channel 43, when the throttle body 1 is moved to the open position (as still seen in FIG. 1), by way of a knob 15 on one end of the throttle body 1. In the FIG. 1 position, air in the drum Interior 25 or 101, is pushed by the drumhead deflection, and with throttling action, through the bore section 40, through holes 6A in body 1, then through channel 43 in valve body 2, then through holes in the throttle body 1, and then to the exterior via porting 41 in the body 1 and port 15A in the knob 15. A metal retaining clip 45 is inserted into a channel around the circumference of throttle body 1 at the opposite end of the knob 15, to engage the inner end 2A of the body 2, in closed position of the valve as seen in FIG. 1A. The closed position of the valve has the knob 15 which is arranged along a centrally aligned radial axis, pulled radially outward from the exterior face of the drum wall shell 13.

Detenting such as interior engageable serrations 30 and 31 (as seen in FIG. 1B), between the throttle body 1 and the spool valve 2 can be provided to retain the body in selected intermediate positions of varied and selected flow throttling positions.

Still referring to FIG. 1A, an O-ring seal 50 seals the gap between the throttle body 1 and the spool valve 2. Clip 3 limits pulling of the body 2, where the O-ring 5 engages a seat 5A.

It may be desirable to include a pressure relief valve on the drum shell 13. The present valve can utilize the formula PV=NRT, where in a storage situation such as travel within in air compartment of an airplane or bus, the drum may become heated either retaining heat pressure air within the drum body itself or on the exterior portion of the body, or the pressure increases inside or outside of he drum causing damage to the drumhead 14.

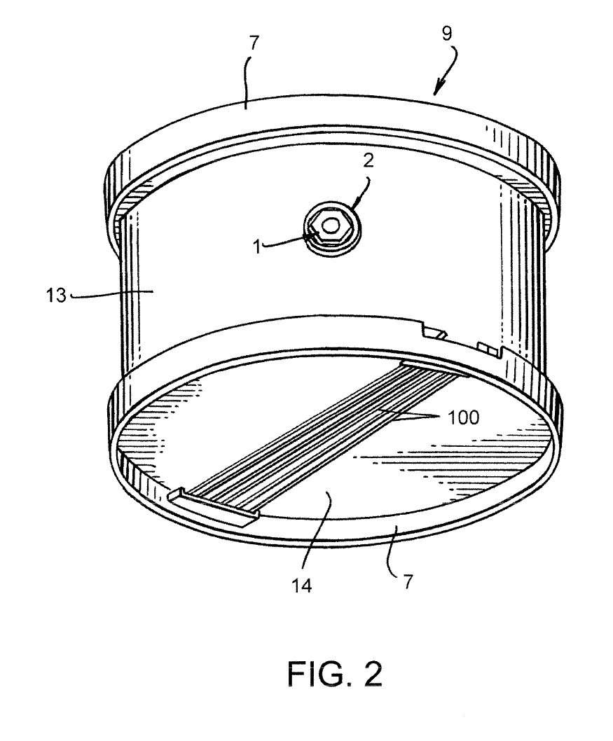

Referring to FIG. 2, the throttle body 1 is installed onto the valve 2 which is shown installed into the shell of the drum 13. In this particular example, a snare drum is utilized. As is conventional, a snare drum includes the shell 13 and a set of snares or wires 100 positioned against the bottom drumhead 14.

In the embodiments, as seen in FIGS. 1 and 2, the valve may be adjusted by pushing or pulling the throttle body 1 as previously discussed along the radially aligned central axis until the desired characteristics of flow control are achieved.

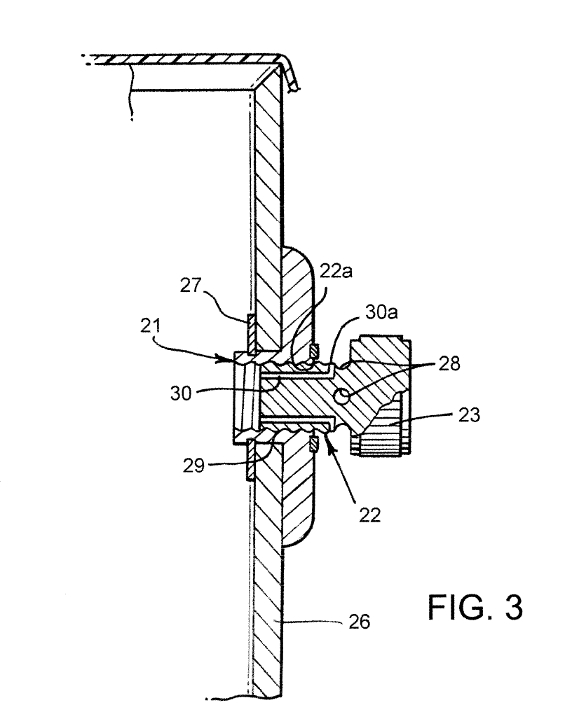

Referring to FIG. 3, the valve 21 which includes the throttle body 22 attached to the drum shell 26 is held in place by a retaining clip 27. The valve throttle body threads at location 29 into the valve 21. A series of holes 28 are placed around the circumference of throttle body 22. The exterior portion of the throttle body 22 has an adjustment knob 23 at the radially outer end. Air in the drum escapes via port 30, when the port exit 30A s retracted past the edge 28 of the body 22.

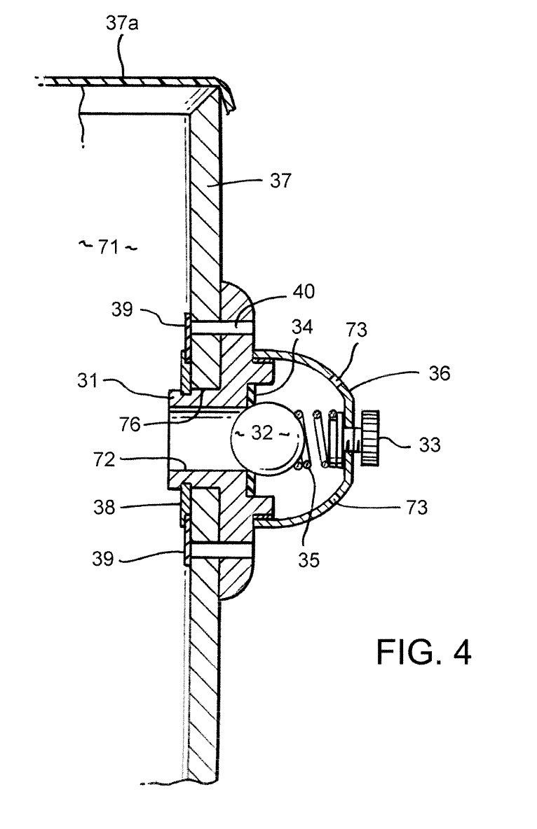

Referring to FIG. 4, an alternative embodiment is shown where the valve 31 is attached to a bore 76 and the drum shell 37 by a valve attachment clip 38. The throttle body ball 32 cell becomes the rubber seal 34 by compression spring 35 having spring constant (K) which has been preselected to maintain a range of pressure against the body ball 32 enabling the user to adjust the control knob 33 for release of automatic pressure in the interior portion of the drum shell 37. The threshold control knob 33 is threaded into the valve exhaust cap 36. The one-way air reintake valve 40 is covered on the inside of the shell by rubber seal 39 which is held in place by the valve attachment clip 38. The seal 39 deflects upon air reintake. A drumhead schematically shown at 37A when the drumhead is deflected towards the drum shell interior portion 71, air exhausts via the valve bore 72, the throttling exhaust port opens when the ball deflects to the right or exterior portion of the drum shell 37, and vents 73 in the cap 36. Throttling at the exhaust port is suggested by turning the knob 33 as previously discussed to variably compress the position of the spring.

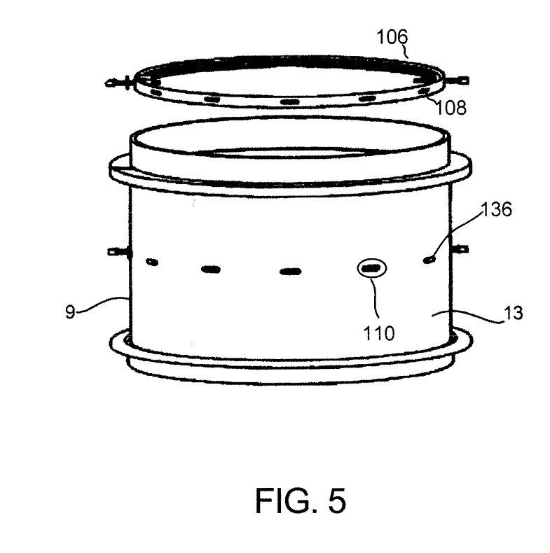

Referring to FIG. 5, an additional embodiment of the concept includes a plurality of acoustic vent openings 13B, each opening positioned around the perimeter of the drum shell 13. A ring member 106 with surfaces defining the openings or slots 108 as shown, in exploded form, is configured as a sliding fit arrangement around the drum shell 13. A seal member 110, which for example may be an O-ring seal, rubber gasket, or sealing grease, is disposed between the ring member 106 and the drum casing 13. The purpose of the O-ring or sealing member 110 is to maintain the airtight capacity of the drum casing and drumheads. The ring member 106 may be disposed on the interior, or alternatively the exterior of the drum shell 13. While a plurality of acoustic vent openings 13B is shown, a single vent opening which interoperates with the ring member 106 may be utilized, where the ring member travels in a circumferential direction about the outside or inside portion of the drum shell.

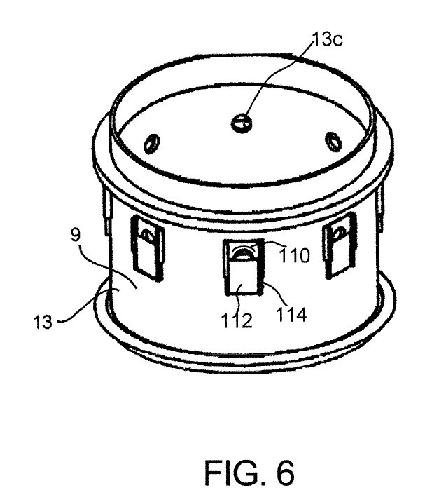

Referring to FIG. 6, an alternative embodiment is provided where one or a series of acoustic vent openings 13C may be positioned about the shell of the drum. The vent openings allow air to enter and exit through the drum 9 while open, and also allow no air to exit or enter when the drum is hermetically sealed through utilization of a sealing member 110 when closed. The valve slides 112 are supported by glides 114 and are movable in vertical direction parallel with the cylindrical walls 13 of the drum shell, and are arranged close to the openings 13C. A sealing member 110 as previously discussed, for example an O-ring seal, rubber gasket, sealing grease etc, is disposed between the valve slides 112 and the drum shell 13. The valve slides 114 may be disposed on the interior or alternatively on the exterior of the drum shell 13.

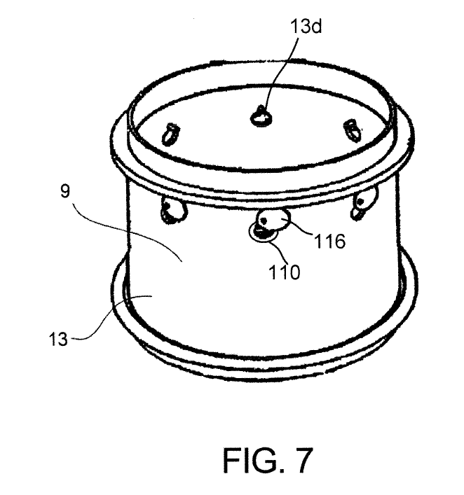

Referring to FIG. 7, a further alternative embodiment is shown. One or more acoustic vent openings 13D which have a circular arrangement, enable air to exit and enter the interior of the drum while open, and hermetically seal the drum 9 when the openings are closed, allowing no air to enter or exit the interior portion of the drum region. Valve discs 116 are positioned next to each opening 13D, each valve disk is pivotable to an open or close vent opening position. The valves are pivotable to slide over the vent openings 13D. The sealing member 110, for example an O-ring seal, rubber gasket, or sealing grease etc, is disposed between the valve discs 116 and the drum shell 13. The valve discs 116 may be disposed on the interior, or alternatively on the exterior of the drum shell 13.

While the present concept is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The present concept in its broader aspects is therefore not limited to the specific details, representative apparatus and methods, and illustrative examples shown and described. Accordingly, departures may be made from such details without departing from the spirit or scope of applicants' general concept.

Therefore I claim:

1. A drum comprising:
a. a cylindrical drum wall comprising a top edge and a bottom edge;
b. a top head arranged about said top edge of said cylindrical drum wall; a bottom head arranged about said bottom edge of said cylindrical drum wall; said top head, said bottom head, and said cylindrical drum wall defining an airtight inner region and an exterior region;
c. said top head configured to be struck by a beater, to create an enhancement of air pressure within said airtight inner region;
d. a first valve arranged on said drum and configured to regulate said enhancement of air pressure between said airtight inner region and said exterior region.

2. The drum according to claim 1 above wherein said first valve further comprises: an adjustable valve comprising a first airflow throttling component.

3. The drum according to claim 2 above wherein said adjustable valve further comprises: a second airflow throttling component.

4. The drum according to claim 1 above wherein said adjustable valve further comprises: a movable adjuster to regulate the flow of air through the valve from said airtight inner region to said exterior region.

5. The drum of claim 1 wherein said first valve is carried by a shell defined by the drum.

6. The drum according to claim 4 wherein said first valve includes a body attached to said drum to extend in said shell, said movable adjuster extending from within said body to said exterior region, for manual displacement between a plurality of selected positions to control said airflow.

7. The drum according to claim 1 wherein said first valve further comprises: a spool valve.

8. The drum according to claim 1 wherein said first valve further comprises: an axially movable adjustable stopper and a seat engageable by said stopper, said stopper accessible from said exterior region.

9. The drum according to claim 8 wherein said movable adjuster further comprises: a plurality of radially extending airflow throttling holes which communicate with said exterior region via a bypass channel, and said movable adjuster further comprising an axial porting which communicates with said plurality of throttling holes and said interior region.

10. The drum according to claim 8 wherein said stopper further comprises: an axis of rotation, said plurality of throttling holes arranged about said stopper axis of rotation.

11. The drum according to claim 1 wherein said drum further comprises: snares configured to interoperate with said bottom head.

12. The drum according to claim 1 wherein said first valve further comprises:
a. a tubular spool and a body defining a bore receiving said spool, a first seal, a second seal, said first and second seals arranged on said spool;
b. a first group of radial ports proximate to said first and second seals to receive said airflow from said inner region via said tubular spool;
c. a bypass channel arranged in said body to receive said airflow from said first group of radial ports;
d. a second group of radial ports arranged proximate to said first and second seals in said spool to receive said airflow from said bypass channel for venting of said airflow to said exterior region via an adjusting knob port.

13. The drum according to claim 12 wherein said first valve further comprises a flow restrictor extending cross-wise of said spool axis.

14. The drum according to claim 4 wherein said first valve further comprises detenting for holding said movable adjuster in any one of a number of positions corresponding to different tonal effects produced during beating.

15. The drum according to claim 4 wherein said first valve further comprises a body attached to a shell defined by the drum, said movable adjuster threaded into said body to allow said movable adjuster rotation for controlling throttling.

16. The drum according to claim 4 wherin said first valve further comprises a body attached to a shell defined by the drum, said moveable adjuster comprising a spring loaded ball seated on a seat, and past which air can escape after deflecting the ball toward the spring, there being a control knob to variably compress the spring between multiple selected portions.

17. The drum according to claim 1 wherein said drum further comprises:
a. a first group of surfaces defining a first group of acoustic vent openings positioned about the drum shell,
b. a first ring member comprising a first group of surfaces defining a first range of openings, said first ring member configured to interoperate about said drum shell, and
c. a first group of sealing members disposed between the ring member and the drum shell.

18. The drum of claim 1 wherein said drum further comprises:
a. a first group of surfaces defining acoustic vent openings configured to allow air to exit from the drum while open, and hermetically seal the drum when closed;
b. a plurality of glides coupled to the drum shell;
c. a plurality of valve slides supported by the glides and movable to close the openings; and
d. a first group of sealing members disposed between the valve slides and the drum shell.

19. The drum of claim 1 wherein the drum further comprises:
a. a first group of acoustic vent openings configured to allow air to exit from the entry of the drum while open, and hermetically seal the drum when closed;
b. a first group of valve discs positioned adjacent to each opening and pivotable to open or close the vent openings; and
c. a first group of sealing members disposed between each of the valve disks and the drum shell.

20. The drum according to claim 1 wherein said first valve further comprises an automatic pressure release valve.
